(19) United States
(12) Patent Application Publication
(10) Pub. No.: US 2017/0274587 A1
(43) Pub. Date: Sep. 28, 2017

(54) LIQUID DROP DISCHARGE DEVICE AND LIQUID DROP DISCHARGE METHOD

(71) Applicant: MIMAKI ENGINEERING CO., LTD., Nagano (JP)

(72) Inventor: Kunio HAKKAKU, Nagano (JP)

(73) Assignee: MIMAKI ENGINEERING CO., LTD., Nagano (JP)

(21) Appl. No.: 15/505,601

(22) PCT Filed: Aug. 25, 2015
(86) PCT No.: PCT/JP2015/073790

§ 371 Date: Feb. 21, 2017

(30) Foreign Application Priority Data
Aug. 25, 2014 (JP) 2014-170675

(51) Int. Cl. B29C 67/00; B41J 2/01

(52) U.S. Cl. CPC B29C 67/0059; B29C 67/0077; B41J 2/01; B33Y 30/00

(57) ABSTRACT

The printing and object-shaping system includes inkjet heads that discharge ink droplets of ultraviolet curing-type inks, a curing unit, a platen which is a table-shaped member disposed so as to face the inkjet heads, and a controller configured to control the operations of at least the inkjet heads and the curing unit. This system is operable to carry out operations in a printing mode and a three-dimensional object shaping mode. The printing mode is a mode for performing printing on a medium supported on the platen. The three-dimensional object shaping mode is a mode for depositing an ink in layers on the platen to form a three-dimensional object. The controller receives an instruction to select one of the printing mode and the three-dimensional object shaping mode and controls the operations of at least the inkjet head and the curing unit in accordance with the mode selected.

### TECHNICAL FIELD

This invention relates to a liquid drop discharge device and a liquid drop discharge method.

### BACKGROUND ART

In recent years, 3D printers developed to form three-dimensional objects are increasingly used for diverse purposes. In the meantime, methods of forming three-dimensional objects are known in the art (inkjet lamination methods) that form the objects by discharging their materials from inkjet heads (recording heads) (for example, Patent Literature 1).

### CITATION LIST

### Patent Literature

Patent Literature 1: Japanese Patent No. 3555968

### SUMMARY

### Technical Problems

The 3D printers can form three-dimensional objects in various shapes in response to supplied data (for example, object-shaping data and coloring data). Desirably, the 3D printers, mostly high-priced devices, are equipped with functions utilizable in a broader range of applications. This invention provides a liquid drop discharge device and a liquid drop discharge method that may fulfill such functions.

### Solutions To Problems

Conventionally, inkjet printers are extensively used that print images and/or characters by the inkjet printing on, for example, planar media (hereinafter, 2D printers). The 2D printer discharges ink droplets from inkjet heads onto a medium to print a two-dimensional image thereon. Some of the 3D printers, as mentioned earlier, are known to form 3D objects using the inkjet heads.

The 2D and 3D printers are traditionally sold as separate devices since the 2D and 3D printers differ variously in their basic operations. Apart from the inkjet printing, 3D objects may be obtained, for example, by curing photo-curing liquids using laser, by melting and solidifying metal powder using laser, or by extrusion-molding thermosoftening resin filaments. However, the 2D printing function is not available in these techniques.

Under the circumstances, the inventors of this application came up with the idea of configuring one printer to operate as 2D and 3D printers by changing an operation mode to be selected in the inkjet printing technique. This may allow a single printer to functionally operate as 2D and 3D printers, and also provide an even broader range of applications, including shaping 3D objects on 2D-printed media, and printing 2D images on 3D-shaped objects. To this end, the invention provides for the following technical features.

[Configuration 1] A liquid drop discharge device is provided that discharges ink droplets by inkjet printing. The device may include an inkjet head that discharges ink droplets of an ink containing a curable resin that is curable under predetermined conditions; a curing unit that cures the curable resin; a table-shaped member disposed at a position so as to face the inkjet head; and a controller configured to control the operations of at least the inkjet head and the curing unit. The liquid drop discharge device may be operable to carry out operations in a printing mode and a three-dimensional object shaping mode. The printing mode may be a mode for performing printing on a medium supported on the table-shaped member. The three-dimensional object shaping mode may be a mode for depositing an ink in layers on the table-shaped member to form a three-dimensional object. The controller may receive an instruction to select one of the printing mode and the three-dimensional object shaping mode, and control the operations of at least the inkjet head and the curing unit in accordance with the mode selected.

In this configuration, the printing mode may be a mode in which the liquid drop discharge device operates as a 2D printer. The liquid drop discharge device, when operating in the printing mode, prints a two-dimensional image on a planar medium, for example. The three-dimensional object shaping mode may be a mode in which the liquid drop discharge device operates as a 3D printer. The liquid drop discharge device, when operating in the three-dimensional object shaping mode, shapes a three-dimensional object by the lamination technique.

As thus-configured, this single device may be allowed to optionally operate as a 2D printer or a 3D printer by selecting one of the modes and having the controller perform control in accordance with the mode selected. This single device may be thereby usable in a broader range of applications.

In this configuration, the ink may be a liquid discharged from the inkjet head. The inkjet head may be a liquid discharge head that discharges liquid by the inkjet printing. The inkjet printing may be specifically a printing technique in which driver elements, such as piezoelectric elements, are driven to discharge ink droplets through nozzles. The inkjet head may perform main scans in which the inkjet head discharges ink droplets while moving in a predetermined main scanning direction, thereby dropping the ink droplets at positions specified by the controller.

[Configuration 2] The liquid drop discharge device may further include a mode changing unit that switches between the printing mode and the three-dimensional object shaping mode. The controller may receive an instruction from a user to select one of the printing mode and the three-dimensional object shaping mode through the mode changing unit. With this technical feature, one of the operation modes may be timely selected in the liquid drop discharge device.

The mode changing unit may accept a user's action performed on the liquid drop discharge device to switch between the printing mode and the three-dimensional object shaping mode. The mode changing unit may include an operating part to accept a user's action performed on the liquid drop discharge device. The operating part may accept a user's action to switch between the printing mode and the three-dimensional object shaping mode. In this manner, one of the operation modes may be timely selected in the liquid drop discharge device.

[Configuration 3] The liquid drop discharge device may be further operable to carry out an operation in an irregularities forming mode to form irregularities on a planar surface. The controller may receive an instruction to select any one of the printing mode, the three-dimensional object shaping mode, and the irregularities forming mode, and control the operations of at least the inkjet head and the curing unit in accordance with the mode selected.

The irregularities forming mode may be a mode for shaping a three-dimensional shape with no overhang on a planar medium. During the irregularities forming mode, the liquid drop discharge device may color the surface of formed irregularities. The liquid drop discharge device may accordingly form surface-colored irregularities on a planar surface. The operation during the irregularities forming mode may be defined as a 2.5-dimensional (hereinafter, 2.5D) operation between two-dimensional image printing and three-dimensional object shaping operations (operation of a 2.5D printer).

By selecting one of the modes and having the controller perform control in accordance with the mode selected, the liquid drop discharge device may be operable to further carry out the functions of a 2.5D printer. This single device may be thereby usable in a broader range of applications.

[Configuration 4] The curable resin may be an ultraviolet curing-type resin curable by being irradiated with ultraviolet light. The curing unit may be an ultraviolet light source that emits ultraviolet light to cure the ultraviolet curing-type resin. The operations in the different operation modes of the liquid drop discharge device may be accordingly carried out in a more suitable manner.

[Configuration 5] The curable resin may an ultraviolet curing-type resin curable by being irradiated with ultraviolet light. The controller may prompt the inkjet head to perform main scans in which the inkjet head discharges the ink droplets while moving in a predetermined main scanning direction. The liquid drop discharge device may include: a plurality of color ink heads as the inkjet head, the plurality of color ink heads discharging ink droplets of color inks having different colors; a clear ink head that discharges ink droplets of a clear ink that is a transparent ink; and a forming material head that discharges ink droplets of a forming ink used to shape the three-dimensional object at least when the three-dimensional object shaping mode is selected. At least when the three-dimensional object that is colored is foil led during the three-dimensional object shaping mode selected, the controller may prompt the plurality of color ink heads and the clear ink head to discharge the ink droplets onto a region to be colored of the three-dimensional object where coloration is visually recognizable from outside of the three-dimensional object. The plurality of color ink heads and the clear ink head may be arranged in the main scanning direction in positional alignment with one another in a direction orthogonal to the main scanning direction. The liquid drop discharge device may further include first and second light sources as the curing unit. The first and second light sources may be ultraviolet light sources that emit ultraviolet light to cure the ultraviolet curing-type resin. The first light source may be disposed on one side in the main scanning direction of the arrangement of the plurality of color ink heads and the clear ink head. The second light source may be disposed on another side in the main scanning direction of the arrangement of the plurality of color ink heads and the clear ink head. The forming material head may be disposed outside of a region between the first and second light sources.

The plurality of color ink heads may be inkjet heads that discharge process color inks. At the time of coloring the region to be colored during the three-dimensional object shaping mode, the different color ink droplets are discharged from the color ink heads to positions in the region to be colored by ratios that allow desired colors to be exhibited at the positions. In this case, however, if the color inks alone are used to form the region to be colored, an ink quantity per unit volume may differ from one position to another depending on colors to be exhibited at the respective positions.

According to the configuration, on the other hand, the clear ink is used for the region to be colored in addition to the color inks. The clear ink head may discharge the ink droplets of the clear ink so as to supplement an ink quantity per unit volume at each position in the region to be colored. This may allow the color inks and the clear ink to amount to a substantially constant volume at different positions in the region to be colored. As a result, the three-dimensional object may be shaped and colored with high precision.

The ink containing the ultraviolet curing-type resin (hereinafter, ultraviolet curing-type ink) may have a degree of viscosity low enough to be dischargeable through nozzles of the inkjet head before the ink starts to be cured by ultraviolet light. During the main scans, therefore, ink dots formed by the ink droplets landing at target positions may continue to spread before ultraviolet irradiation starts. As such, a length of time between the arrival of ink droplets and the start of ultraviolet irradiation may be the deciding factor of the cured ink dot size (dot gain). The ink dot may decrease in height as the ink dot gain increases.

In case the ink dots variously differ in height during the manufacture of a three-dimensional object, high shaping precision may not be attainable. To be more specific, during the three-dimensional object shaping mode, the ink droplets are discharged for the region to be colored from the color ink heads and the clear ink head. Greater differences among gains of the ink dots formed then by these inkjet heads may lead to greater differences in height among the ink dots, making it difficult to attain high shaping precision.

To address the issue, the color ink heads and the clear ink head, which are inkjet heads that discharge the ink droplets for the region to be colored, are arranged next to one another between the first and second light sources. This may avoid too large differences in time between the arrival of ink droplets and the start of ultraviolet irradiation among these inkjet heads during the main scans. This may adequately suppress gain differences among the ink dots formed by the inkjet heads, allowing the colored three-dimensional object to be shaped with high precision.

If an unnecessarily large number of inkjet heads are interposed between the first and second light sources, the light sources are inevitably further spaced apart from each other. This may involve the risk of increasing differences in time between the arrival of ink droplets and the start of ultraviolet irradiation among the inkjet heads interposed between the first and second light sources during the main scans. According to this configuration, the forming material head, which is an inkjet head not discharging the ink droplets for the region to be colored, is disposed outside of a region between the first and second light sources, instead of being interposed between these light sources. This may appropriately prevent an interval between the first and second light sources from increasing more than required. This may also adequately suppress gain differences of the ink dots among the inkjet heads interposed between the first and second light sources, thereby serving to ensure high precision in the process of shaping the colored three-dimensional object.

[Configuration 6] The forming material head may be positioned across the second light source from the arrangement of the color ink heads and the clear ink head. The inkjet heads may be accordingly arranged in a suitable manner, and the colored three-dimensional object may be more appropriately shaped with high precision.

[Configuration 7] The device may further include a third light source as the curing unit. The third light source may be an ultraviolet light source that emits ultraviolet light for curing the ultraviolet curing-type resin. The third light source may be positioned opposite to the second light source across the forming material head in the main scanning direction. This may allow the ink dots formed by the forming material head to be adequately cured.

In this configuration, the inkjet heads may perform main scans forward and backward in the main scanning direction. With this technical feature, the operations in the different operation modes may be more speedily carried out.

[Configuration 8] A liquid drop discharge method is provided that discharges ink droplets by inkjet printing. The method may include receiving an instruction to select one of a printing mode and a three-dimensional object shaping mode. The printing mode may a mode for performing printing on a medium supported on a table-shaped member facing the inkjet head. The printing mode may include use of an inkjet head that discharges ink droplets of an ink containing a curable resin that is curable under predetermined conditions; a curing unit that cures the curable resin; and the table-shaped member. The three-dimensional object shaping mode may be a mode for depositing an ink in layers on the table-shaped member to form a three-dimensional object. The method may further include controlling the operations of at least the inkjet head and the curing unit in accordance with the mode selected. This method may attain effects similar to the effects that may be attainable by the Configuration 1.

### Effect Of The Invention

According to this invention, the liquid drop discharge device may be usable in a broader range of applications. To be specific, a single liquid drop discharge device may be allowed to at least functionally operate as 2D and 3D printers.

### BRIEF DESCRIPTION OF THE DRAWINGS

FIG. 1 is a block diagram of exemplified principal structural elements in a printing and object-shaping system 10 according to an embodiment of this invention.

FIGS. 2A and 2B are drawings of exemplified structural elements and an exemplified operation of a discharge unit 12. FIG. 2A is a drawing of a detailed structure of the discharge unit 12. FIG. 2B is a drawing of an exemplified three-dimensional object 5 shaped by an operation during a three-dimensional object shaping mode.

FIGS. 3A and 3B are schematic drawings that illustrate a detailed structure of the three-dimensional object 5 shaped in the embodiment. FIG. 3A is a drawing of the three-dimensional object 5 in vertical cross section. FIG. 3B is a drawing of the three-dimensional object 5 in horizontal cross section.

FIGS. 4A and 4B are drawings that specifically illustrate ink layers 5a (n) and 5a (n+1) formed in the three-dimensional object shaping mode. FIG. 4A is a schematic drawing of an exemplified state of the layer 5a (n). FIG. 4B is a schematic drawing of an exemplified state of the layer 5a (n+1).

FIGS. 5A and 5B are drawings that illustrate operation modes other than the three-dimensional object shaping mode. FIG. 5A is a drawing that illustrates an exemplified operation during a printing mode. FIG. 5B is a drawing that illustrates an exemplified operation during an irregularities forming mode.

FIG. 6 is a table showing exemplified operation modes of the printing and object-shaping system 10.

### DESCRIPTION OF EMBODIMENTS

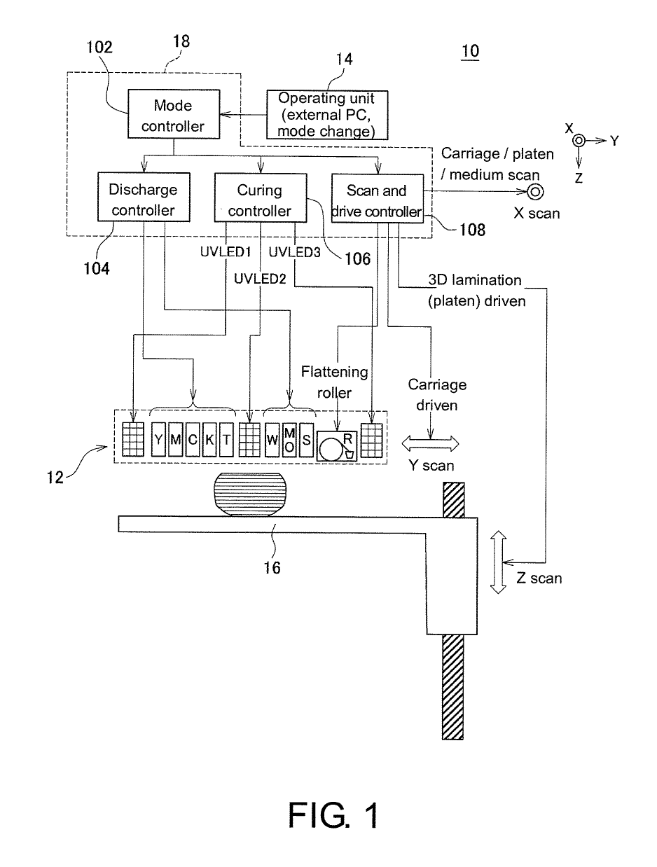

Hereinafter, an embodiment of this invention is described referring to the accompanying drawings. FIG. 1 is a block diagram of exemplified principal structural elements in a printing and object-shaping system 10 according to an embodiment of this invention.

In this embodiment, the printing and object-shaping system 10 is described as an example of the liquid drop discharge device that discharges the ink droplets by the inkjet printing. This system carries out at least a two-dimensional image printing operation and a three-dimensional object shaping operation based on, for example, instructions from a user (operator). The two-dimensional image printing operation may be an operation carried out by a 2D inkjet printer such as a known inkjet printer. The three-dimensional object shaping operation may be an operation to shape, for example, a three-dimensional object 5 by the lamination technique. The lamination shaping technique may form and stack plural layers on one another to obtain a three-dimensionally structured object. The three-dimensional object shaping operation may be an operation carried out by a known 3D printer. In this embodiment, the printing and object-shaping system 10 further carries out a 2.5-dimensional operation (operation of a 2.5D printer). The 2.5-dimensional may be defined as an operation between the two-dimensional image printing operation and the three-dimensional object shaping operation.

As described in detail below, the printing and object-shaping system 10 according to this embodiment carries out one of the operations in different modes (hereinafter, operation modes) set in response to a user's action performed on the system. The operation modes include a mode for printing two-dimensional images (hereinafter, printing mode), a mode for shaping three-dimensional objects (three-dimensional object shaping mode), and a mode for 2.5-dimensionally forming irregularities (irregularities forming mode). The operations in these operation modes will be described later in further detail.

Except for the technical aspects hereinafter described, the printing and object-shaping system 10 may be functionally and structurally identical or similar to the known printing devices or three-dimensional object forming devices. The printing and object-shaping system 10 may include a known inkjet printer partly modified to carry out the printing and 3D shaping operations. For example, a partly modified inkjet printer configured to print two-dimensional images using ultraviolet curing-type inks (UV inks) may constitute at least part of the printing and object-shaping system 10.

The printing and object-shaping system 10 includes a discharge unit 12, an operating unit 14, a platen 16, and a controller 18. The discharge unit 12 discharges ink droplets of printing and 3D-shaping inks. The discharge unit 12 includes, for example, a plurality of inkjet heads and ultraviolet light sources. The inkjet heads discharge ink droplets of ultraviolet curing-type inks. The ultraviolet curing-type ink is an example of the ink containing a curable resin that is curable under predetermined conditions. The ultraviolet curing-type ink is an example of photo-curing inks. The ink may be a liquid discharged from the inkjet head. The ultraviolet light source is an example of the curing unit used to cure the curable resin. The ultraviolet light source irradiates ink dots formed by ink droplets landing at target positions with ultraviolet light to cure the ink dots. Specific configuration of the discharge unit 12 will be described later in further detail.

The operating unit 14 accepts a user's action performed on the printing and object-shaping system 10. The operating unit 14, by accepting the user's action, operates as the mode changing unit that changes an operation mode to be selected in the printing and object-shaping system 10. In this embodiment, the operating unit 14 may be a host PC provided outside of a device in charge of, for example, the printing and 3D shaping operations in the printing and object-shaping system 10 (hereinafter, main device of the printing and object-shaping system 10). The operating unit 14 may be an operation panel of the device in charge of, for example, the printing and 3D shaping operations.

The platen 16 is a table-shaped member disposed at a position opposite to the discharge unit 12. In this embodiment, the platen 16 holds, on its upper surface, a target object to which the ink droplets are discharged in accordance with the operation mode selected in the printing and object-shaping system 10. In the operation during the two-dimensional printing mode, for example, the platen 16 holds a print target medium on its upper surface. In the operation during the three-dimensional object shaping mode, the platen 16 holds, on its upper surface, a three-dimensional object being shaped at the time. In the operation during the 2.5-dimensional irregularities forming mode, the platen 16 holds, on its upper surface, a base on which irregularities are being formed (object-shaping base such as a resin plate) or the object being formed as in the three-dimensional object shaping mode.

In this embodiment, the platen 16 is allowed to at least move upward and downward (Z direction in the drawing). The direction indicated by upward and downward is a direction perpendicular to the upper surface of the platen 16. The printing and object-shaping system 10 performs scans in the Z direction by thus moving the platen 16 upward and downward as the object shaping operation advances at least when operating in the three-dimensional object shaping mode and the irregularities foaming mode.

The controller 18 is configured to control the operations of the components in the printing and object-shaping system 10. The controller 18 may control the operations of the respective components in the printing and object-shaping system 10 in accordance with instructions received from a user through the operating unit 14. In this embodiment, the controller 18 includes a mode controller 102, a discharge controller 104, a curing controller 106, and a scan and drive controller 108.

The mode controller 102 may control the operation modes in the printing and object-shaping system 10. More specifically, the mode controller 102 may receive a user's choice for the operation modes through the operating unit 14. Depending on which one of the operation modes is selected at the time, the mode controller 102 controls the operations of the discharge controller 104, curing controller 106, and scan and drive controller 108.

The discharge controller 104 controls the timing of the ink droplets being discharged from the inkjet heads of the discharge unit 12. The curing controller 106 controls the timing of ultraviolet light being emitted from the ultraviolet light sources of the discharge unit 12, thereby controlling the operation to cure the inks.

The scan and drive controller 108 controls the operation of a driving source (such as a motor) that drives the discharge unit 12 and the platen 16 to move, thereby controlling scans performed by the discharge unit 12. Specifically, the scan and drive controller 108 may prompt the discharge unit 12 to perform main scans in accordance with the shape of an image to be printed or a three-dimensional object to be shaped. Prompting the discharge unit 12 to perform main scans may be specifically prompting the inkjet heads of the discharge unit 12 to perform main scans. The main scan may be an operation in which the discharge unit 12 discharges the ink droplets while moving in a preset main scanning direction (Y direction in the drawing). During the main scans, the discharge unit 12 may move relative to the platen 16.

As described earlier, the printing and object-shaping system 10 performs scans in the Z direction by moving the platen 16 upward and downward at least when operating in the three-dimensional object shaping mode and the irregularities forming mode. In this instance, the scan and drive controller 108 may move the platen 16 in a direction away from the discharge unit 12 as the object shaping operation advances.

In FIG. 1, the mode controller 102, discharge controller 104, curing controller 106, and scan and drive controller 108 are illustrated in different blocks as per the functions carried out by the controller 18. The mode controller 102, discharge controller 104, curing controller 106, and scan and drive controller 108 may not necessarily be physically divided in separate units. The controller 18 may be the CPU of the main device of the printing and object-shaping system 10. In this instance, the CPU may operate as the mode controller 102, discharge controller 104, curing controller 106, and scan and drive controller 108 as prompted by a preset program. Otherwise, separate control circuits, for example, may be used as at least part of the mode controller 102, discharge controller 104, curing controller 106, and scan and drive controller 108. In this instance, the CPU may operate as the separate control circuits, discharge controller 104, curing controller 106, and scan and drive controller 108.

The printing and object-shaping system 10 may further include any devices necessary for the printing and object-shaping operations in addition to those illustrated in the drawings. For example, the printing and object-shaping system 10 may further include a sub scan driving unit that prompts the discharge unit 12 to perform sub scans. The sub scan is an operation in which the inkjet heads of the discharge unit 12 are moved relative to the platen 16 in a sub scanning direction orthogonal to the main scanning direction (X direction in the drawing).

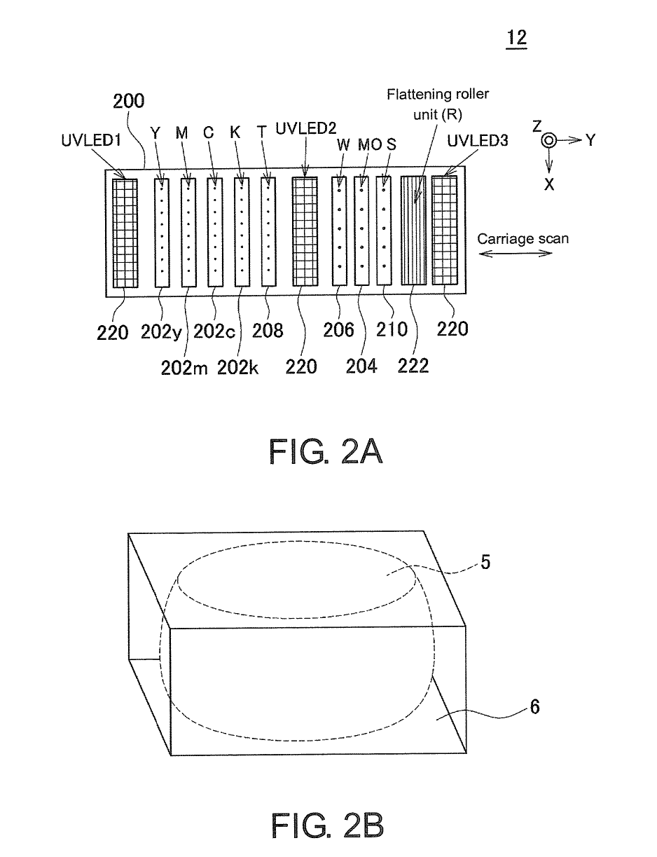

The discharge unit 12 is hereinafter described in further detail. FIGS. 2A and 2B are drawings of exemplified structural elements and an exemplified operation of the discharge unit 12. FIG. 2A is a drawing of a detailed structure of the discharge unit 12.

In this embodiment, the discharge unit 12 includes a carriage 200, a plurality of inkjet heads, a plurality of ultraviolet light sources 220, and a flattening roller unit 222. The inkjet heads of the discharge unit 12 are color ink heads 202y, 202m, 202c, and 202k (hereinafter, color ink heads 202y-k), a clear ink head 208, a white ink head 206, a forming material head 204, and a support material head 210.

The carriage 200 is a member in which the other components of the discharge unit 12 are held so as to face the platen 16. For example, the carriage 200, while holding the components, moves in the main scanning direction (Y direction) as prompted by the scan and drive controller 108 (see FIG. 1) during the main scans.

The color ink heads 202y-k, clear ink head 208, white ink head 206, forming material head 204, and support material head 210 are each an example of the inkjet head that discharges, for example, the ink droplets of the curable resin-containing ink by the inkjet printing. In this embodiment, the color ink heads 202y-k, clear ink head 208, white ink head 206, forming material head 204, and support material head 210 are inkjet heads that discharge, for example, ink droplets of ultraviolet curing-type inks. These ink heads are arranged in the main scanning direction (Y direction) in positional alignment with one another in the sub scanning direction (X direction).

Suitable ones of the known inkjet heads may be used as the color ink heads 202y-k, clear ink head 208, white ink head 206, forming material head 204, and support material head 210. These inkjet heads respectively have, on their surfaces facing the platen 16 (see FIG. 1), nozzle arrays each having a plurality of nozzles aligned in the sub scanning direction. The nozzle arrays of the inkjet heads extend in the same direction in parallel with one another. During the main scans, the nozzle arrays, while moving in the main scanning direction orthogonal to the nozzle array-aligned direction, discharge the ink droplets in the Z direction.

The color ink heads 202y-k are inkjet heads that respectively discharge ink droplets of different color inks. In this embodiment, the color ink heads 202y-k respectively discharge ink droplets of ultraviolet curing-type inks in colors of Y (yellow), M (magenta), C (cyan), and K (black). The colors of Y, M, C, and K are examples of the process colors. In a modified example, the discharge unit 12 may further include color ink heads for color inks in pale colors of the before-mentioned colors, and R (red), G (green), B (blue), orange, metallic, and other color inks. The inks in some or all of the inkjet heads used as the color ink heads, depending on an intended use, may be replaced with other inks.

The clear ink head 208 is an inkjet head that discharges ink droplets of an ultraviolet curing-type clear ink. The clear ink is a clear-color ink having a transparent color (T). The clear ink may be an ink containing an ultraviolet curing-type resin but containing no colorant. The clear ink may be a colorless transparent ink. The white ink head 206 is an inkjet head that discharges ink droplets of a white (W) ultraviolet curing-type ink.

The forming material head 204 is an inkjet head that discharges ink droplets of an ultraviolet curing-type ink used to form the interior or the like of a three-dimensional object. In this embodiment, the forming material head 204 discharges ink droplets of a forming ink (MO) having a predetermined color. The forming ink may be solely for use in shaping the object. The forming ink may be a white ink or a clear ink.

In this embodiment, the forming material head 204 may be used when the operation mode selected is the three-dimensional object shaping mode and the irregularities forming mode. The forming material head 204 is not used when the printing mode is selected.

The support material head 210 is an inkjet head that discharges ink droplets including a support material (support material S) to form a support around a three-dimensional object being shaped. In this instance, the “support” may be a laminate structure (support layers) surrounding and supporting a three-dimensional object being shaped. The support material may be a water-soluble material that can be dissolved in water after the formation of a three-dimensional object is completed. The support material, which will be removed after the object is obtained, may be selected from materials having lower ultraviolet curability and easier to dissolve than the inks used to form a three-dimensional object. The support material may be selected from suitable ones of the known support materials.

In this embodiment, the support material head 210 may be used when the three-dimensional object shaping mode is selected. The support material head 210 is not used when the operation mode selected is the irregularities forming mode and the printing mode.

The ultraviolet light sources 220 are light sources that emit ultraviolet light to cure the ultraviolet curing-type inks. This embodiment uses UVLEDs (ultraviolet LEDs) as the ultraviolet light sources 220. Other examples of the ultraviolet light sources 220 may include metal halide lamps and mercury lamps.

The discharge unit 12 has three ultraviolet light sources 220 indicated with UVLED1 to UVLED3 in the drawing. The ultraviolet light source 220 indicated with UVLED1, (hereinafter, UVLED1) is an example of the first light source. The ultraviolet light source 220 indicated with UVLED2, (hereinafter, UVLED2) is an example of the second light source. The ultraviolet light source 220 indicated with UVLED3, (hereinafter, UVLED3) is an example of the third light source.

In this embodiment, the color ink heads 202y-k and the clear ink head 208 are arranged next to one another in the main scanning direction, as illustrated in the drawing. The UVLED1 is disposed on one side in the main scanning direction of the arrangement of the color ink heads 202y-k and the clear ink head 208. The UVLED2 is disposed on the other side in the main scanning direction of the arrangement of these ink heads.

The color ink heads 202y-k and the clear ink head 208 are disposed in a region between the UVLED1 and UVLED2. The white ink head 206, forming material head 204, and support material head 210, which are inkjet heads other than the color ink heads 202y-k and the clear ink head 208, are disposed outside of the region between the UVLED1 and UVLED2.

The white ink head 206, forming material head 204, and support material head 210 are positioned across the UVLED2 from the arrangement of the color ink heads 202y-k and the clear ink head 208. The UVLED3 is positioned opposite to the UVLED2 across the white ink head 206, forming material head 204, and support material head 210. The white ink head 206, forming material head 204, and support material head 210 are accordingly disposed in a region between the UVLED2 and UVLED3. The reason of such arrangement of these ink heads and light sources will be described later.

The flattening roller unit 222 flattens layers made of the ultraviolet curing-type inks that are formed while the three-dimensional object is being shaped during the three-dimensional object shaping mode. The flattening roller unit 222 may also flatten the layers during the irregularities forming mode. The flattening roller unit 222 is disposed at a position between the UVLED3 and the arrangement of the white ink head 206, forming material head 204, and support material head 210. The flattening roller unit 222 is disposed in juxtaposition with the inkjet heads of the discharge unit 12 in the main scanning direction in positional alignment with these inkjet heads in the sub scanning direction.

The flattening roller unit 222, an exemplified flattening mechanism to carry out flattening, has a roller that flattens the ink layer surfaces. The flattening roller unit 222 may be driven by a driving mechanism, not illustrated in the drawings, to move upward and downward (Z direction) relative to the position of the whole discharge unit 12. The flattening roller unit 222 thus functionally configured moves to a position that allows for contact with the ink layer solely at the time of flattening the ink layer. The flattening roller unit 222 may contact the ink layer only when the ink layer is flattened by moving the platen 16 in the direction of Z axis, with the lower end of the roller being fixed to a position below the lower ends of the heads.

The discharge unit 12 thus characterized operates as prompted by the controller 18 in the selected operation mode to discharge the ink droplets. The operations during the different operation modes are hereinafter described in further detail. First, the three-dimensional object shaping mode is described. In this embodiment, the three-dimensional object shaping mode is an operation mode for shaping a three-dimensional object by, for example, depositing the inks in layers on the platen 16.

FIG. 2B is a drawing of an exemplified three-dimensional object 5 shaped by the operation during the three-dimensional object shaping mode. During the three-dimensional object shaping mode, the discharge unit 12 may discharge the ink droplets from all of the inkjet heads but the support material head 210 to shape the three-dimensional object 5. By further using the support material head 210, a support 6 is formed around the three-dimensional object 5.

The three-dimensional object 5 is formed by repeatedly performing a layer forming step of forming the ink layers using the ultraviolet curing-type inks and a curing step of curing the ink layers made of the ultraviolet curing-type inks by irradiating them with ultraviolet light. In these steps, the discharge unit 12 forms and stacks up the cured ink layers made of the ultraviolet curing-type inks. To obtain the colored three-dimensional object 5, the surface of the three-dimensional object 5 may be colored with the inks discharged from the color ink heads 202y-k.

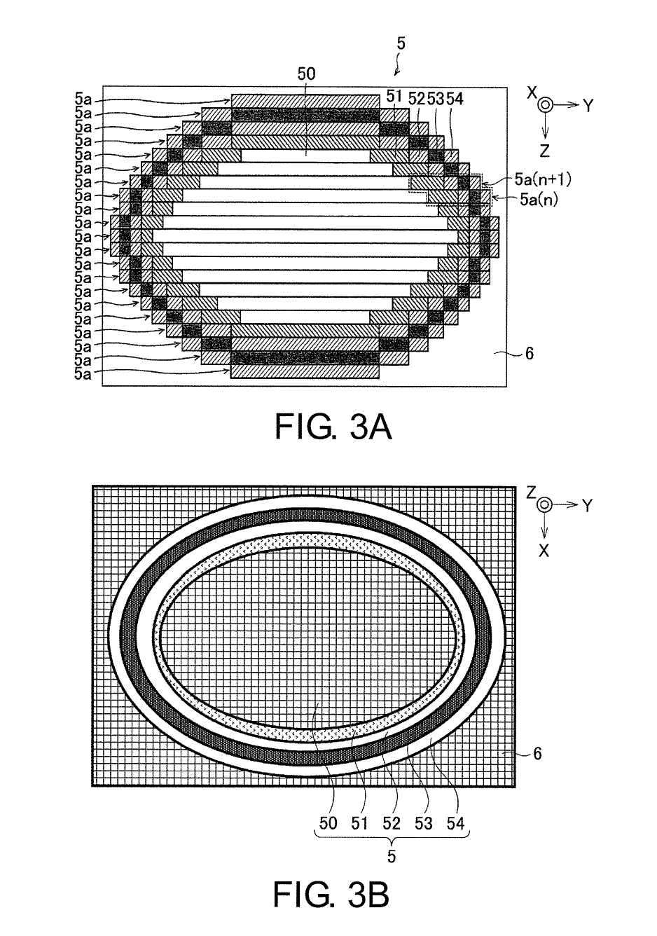

In connection with the operation during the three-dimensional object shaping mode, a specific example of an operation to shape the colored three-dimensional object 5 is hereinafter described. FIGS. 3A and 3B are schematic drawings that illustrate a detailed structure of the three-dimensional object 5 for lied in this embodiment. FIG. 3A is a drawing of the three-dimensional object 5 in vertical cross section. FIG. 3B is a drawing of the three-dimensional object 5 in horizontal cross section.

As described earlier, the printing and object-shaping system 10 in this embodiment, during the three-dimensional object shaping mode, carries out the layer forming step and the curing step repeatedly and thereby form a plurality of ink layers made of the ultraviolet curing-type inks to obtain the three-dimensional object 5. Specifically, for example, layers indicated with a reference sign 5a in FIG. 3A are formed and stacked on one another to form the three-dimensional object 5. Then, the support 6 is formed around the three-dimensional object 5 by means of the support material head 210 of the discharge unit 12. In this manner, the printing and object-shaping system 10 forms the optionally shaped three-dimensional object 5 with an overhanging portion.

The step of forming the layers (layers 5a) constituting the three-dimensional object 5 in this embodiment will be described in further detail referring particularly to layers 5a (n) and 5a (n+1) illustrated in FIG. 3A. The layers 5a (n) and 5a (n+1) may be the n^{th} layer and the (n+1)^{th} layer from the bottom.

In this embodiment, the printing and object-shaping system 10 forms layers made of the ultraviolet curing-type inks and each including an inner region and an outer peripheral region in the layer forming step. The inner region constitutes the interior of the three-dimensional object 5. The outer peripheral region is a region where, for example, the coloration of the three-dimensional object 5 is visually recognizable from outside (contour region). In this embodiment, the printing and object-shaping system 10 forms, as the inner region, an inner body region 50, an inner white region 51, and an inner clear region 52. Further, the printing and object-shaping system 10 forms, as the outer peripheral region, a region to be colored 53 and an outer clear region 54.

The inner body region 50 is a region constituting the innermost portion of the three-dimensional object 5 to be shaped. The innermost portion of the three-dimensional object 5 may be parts of the layers formed in the layer forming step that are surrounded by the other regions (inner white region 51, inner clear region 52, region to be colored 53, and outer clear region 54). In this embodiment, the printing and object-shaping system 10 forms the inner body region 50 by using at least the forming material head 204.

The inner body region 50 is a region serving as object-shaping layers constituting the core part of the three-dimensional object 5. The inner body region 50 may be a partly hollowed region.

The inner white region 51 is a region formed of white layers in adjacency to the inner body region 50 so as to surround the inner body region 50. On the outer side of the three-dimensional object 5, the inner white region 51 is formed next to the inner clear region 52 in contact with the region to be colored 53. The inner white region 51 thus formed may reflect incident light transmitting through the region to be colored 53 from outside of the three-dimensional object 5. The region to be colored 53 may be accordingly presented in colors produced by the subtractive color mixture. This may allow the coloration of the region 53 to be visually recognized when viewed from outside of the three-dimensional object 5.

In this embodiment, the white ink head 206 may be used to form the inner white region 51. The color of the inner white region 51 may be white or nearly white to the extent sufficient to allow for color representations by the subtractive color mixture.

The inner clear region 52 is formed around the inner body region 50 on the outer side of the inner white region 51. The inner clear region 52 is interposed between and in contact with the inner white region 51 and the outer region to be colored 53. In this embodiment, the clear ink head 208 is used to form the inner clear region 52. The white ink of the inner white region 51 and the Y, M, C, and K inks of the region to be colored 53 may be prevented by the inner clear region 52 from bleeding into one another at the time of flattening the ink layers. The flattening roller unit 222 may accordingly flatten the ink layers in a more appropriate manner.

The region to be colored 53 is formed around the inner body region 50 on the outer side of the inner white region 51 and the inner clear region 52. In this embodiment, the region to be colored 53 constitutes the contour region of the three-dimensional object 5 where the coloration of this object is visible from outside of the object 5 through the outer clear region 54.

The printing and object-shaping system 10 may color the region to be colored 53 by discharging the ink droplets of the Y, M, C, and K inks from the color ink heads 202y-k onto the region to be colored 53. The controller 18 prompts the color ink heads 202y-k to discharge the ink droplets based on an image indicative of color image information to color the region 53. In this embodiment, the printing and object-shaping system 10 uses, as the inkjet heads that discharge the ink droplets onto the region to be colored 53, the clear ink head 208 in addition to the color ink heads 202y-k. Thus, the printing and object-shaping system 10 forms the region to be colored 53 using the Y, M, C, and K inks and the clear ink.

The three-dimensional object 5, depending on its intended use, may be partly colored. In any portion of the object to be left uncolored, the clear ink alone may be used to form the region to be colored 53, or the region to be colored 53 may not be formed in part of such a portion.

The outer clear region 54 is formed around the inner body region 50 on the outer side of the inner white region 51, inner clear region 52, and region to be colored 53. The outer clear region 54 constitutes the outermost surface of the three-dimensional object 5. In this embodiment, the clear ink head 208 is used to form the outer clear region 54. The outer clear region 54 may serve to adequately protect the surface of the three-dimensional object 5, and thereby is expected to prevent the region to be colored 53 from being discolored under exposure to ultraviolet ray of natural light. As thus far described, this embodiment may allow the three-dimensional object 5 to be appropriately formed and colored.

To color the region 53, the ink droplets of the Y, M, C, and K color inks are discharged to positions in this region 53 by ratios that allow desired colors to be exhibited at the positions. The positions in the region to be colored 53 may mean a region including a plurality of ink landing positions (droplet landing positions) in proximity. The ink landing positions may be landing positions of the ink droplets discharged during the main scans. In case the color inks alone are used for the region to be colored 53, an ink quantity per unit volume may differ from one position to another depending on colors to be exhibited at the respective positions.

In this embodiment, the color inks and the clear ink are used to form the region to be colored 53, instead of the color inks alone. The clear ink head 208 may discharge the ink droplets of the clear ink to the region to be colored 53 so as to supplement an ink quantity per unit volume at each position in the region to be colored 53. This may allow the color inks and the clear ink to amount to a substantially constant volume at different positions in the region to be colored 53. According to this embodiment, therefore, the three-dimensional object 5 may be suitably formed and colored with high precision.

Though not illustrated in the drawings, the printing and object-shaping system 10 may form the colorless three-dimensional object 5 during the three-dimensional object shaping mode. In this instance, the three-dimensional object 5 may solely consist of a region equivalent to the inner body region 50, or may further include, for example, a region equivalent to the outer clear region 54, if necessary.

Next, the step of forming the layers constituting the three-dimensional object 5 during the three-dimensional object shaping mode is described in further detail. In this embodiment, the inkjet heads of the discharge unit 12 perform main scans forward and backward in the main scanning direction. The discharge unit 12 prompts the flattening roller unit 222 to flatten the ink layers in one of the forward and backward main scans by the inkjet heads.

Specifically, the flattening roller unit 222 does not flatten the ink layers in the forward main scans but flattens the layers in the backward main scans alone. The discharge unit 12, using a driving mechanism that drives the flattening roller unit 222 to move, makes the flattening roller unit 222 contact the ink layers in the backward main scans alone.

In each main scan, ultraviolet light is emitted from one of the ultraviolet light sources 220 on the rear side of the inkjet heads. The rear side of the inkjet heads refers to the rear side of the inkjet heads in the moving direction in each main scan.

Between the main scans, the platen 16 is moved downward (in the Z direction) by a predetermined height dimension enough for the thickness of the next ink layer to be formed. In this embodiment, the platen 16 is moved downward in consideration of the thickness of the inks flattened and removed by the flattening roller unit 222.

In this embodiment, the platen 16 may be moved downward in the Z direction as a Z direction scan for each round of forward and backward main scans. For example, the scan and drive controller 108 moves the platen 16 by a height dimension obtained by subtracting, from the total thickness of two ink layers formed by the main scans without being flattened, the thickness of the inks flattened and removed. When, for example, the thickness of one ink layer formed by the main scans without being flattened is approximately 20 μm, the total thickness of two ink layers is approximately 40 μm. In case the thickness of the inks flattened and removed is approximately 8 μm, the platen 16 is moved downward by approximately 32 μm.

By performing the main scans and the Z direction scans repeatedly, the colored three-dimensional object 5 may be successfully obtained. In each main scan involving the flattening by the flattening roller unit 222, the lower end of the flattening roller unit 222 is constantly at a vertical position (position in the Z direction). The flattening roller unit 222, therefore, flattens each ink layer by a dimension corresponding to the moving distance of the platen 16 before the flattening (for example, 32 μm). Accordingly, the ink layers may be adequately flattened with high precision.

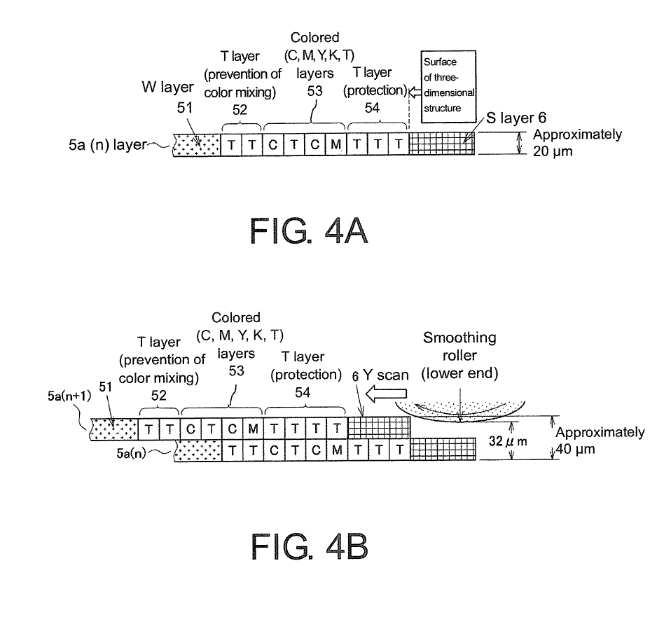

The ink layers formed in this embodiment are described in further detail. FIGS. 4A and 4B are drawings that specifically illustrate ink layers formed in the three-dimensional object shaping mode: 5a (n) layer and 5a (n+1) layer. These layers are indicated in FIG. 3A with reference signs 5a (n) and 5a (n+1).

FIG. 4A is a schematic drawing of an exemplified state of the layer 5a (n). In the illustrated example, the 5a (n) layer is an ink layer formed by, for example, the main scans performed forward in the main scanning direction. During the main scan, the discharge unit 12 may discharge the ink droplets while moving rightward on the drawing. When the discharge unit 12 of FIGS. 2A and 2B is used, among the inkjet heads that discharge the ink droplets for the region to be colored 53, the ink droplets of the clear ink (T) discharged from the clear ink head 208 at the right end are the first to land on the region to be colored 53. Then, the K, C, M, and Y ink droplets discharged from the inkjet heads successively land on this region in the order of their arrangement from right to left.

In FIGS. 4A and 4B, each ink dot formed by one ink droplet is schematically drawn in a square shape for illustrative purposes. In practice, adjacent ones of the ink dots are formed so as to at least partly overlap with each other. The ink dot formed by the ink droplet landing later overlays the ink dot formed by the ink droplet landing earlier.

In the forward and backward main scans, the discharge unit 12 prompts the inkjet heads for the respective regions to discharge the ink droplets to form the inner white region 51, inner clear region 52, and outer clear region 54, as well as the region to be colored 53, as illustrated in the drawings. The discharge unit 12 forms the support 6 on the outer side of the surface of the three-dimensional object 5 indicated with a broken line in the drawings.

FIG. 4B is a schematic drawing of an exemplified state of the 5a (n+1) layer. In the illustrated example, the 5a (n+1) layer is an ink layer formed by the main scan performed backward in the main scanning direction. During the main scan, the discharge unit 12 may discharge the ink droplets while moving leftward on the drawing. When the discharge unit 12 according to this embodiment is used to discharge the ink droplets at the same position of the three-dimensional object 5, the ink droplets discharged from the inkjet heads successively land at the position in the order of their arrangement from left to right. To be more specific, among the inkjet heads that discharge the ink droplets for the region to be colored 53, the ink droplets discharged from the leftmost color ink head 202y are the first to land on the region 53. Then, the M, C, K, and T ink droplets discharged from the inkjet heads successively land on this region in the order of their arrangement from left to right. The ink droplets of the clear ink (T) are the last to land on the region to be colored 53.

As described earlier, adjacent ones of the ink dots that are actually formed at least partly overlap with each other, for example. As per the droplet landing order, the dot of the clear ink (T) landing later than the other color inks at the region to be colored 53 of the 5a (n+1) layer is formed on the dots of the other color inks. Thus, it may be at least avoided that the dots of color inks such as the Y, M, C, and K color inks overlay the dot of the clear ink (T).

During the backward main scan, the flattening roller unit 222 mostly contacts the clear ink. This may prevent that color inks such as the Y, M, C, and K color inks in the region to be colored 53 are disturbed by the flattening roller unit 222. This may also prevent the different color inks from bleeding into one another, thereby avoiding color smearing or the like. A similar effect may be obtained when the flattening roller unit 222 contacts the clear ink of the inner clear region 52 and the outer clear region 54.

As described earlier in connection with FIGS. 4A and 4B, the lower end of the flattening roller unit 222 is constantly at a vertical position (position in the Z direction) in each main scan. The flattening roller unit 222, therefore, flattens each ink layer by a dimension corresponding to the moving distance of the platen 16 before the flattening (for example, 32 μm). Accordingly, the ink layers may be adequately flattened with high precision.

As described earlier, in this embodiment, the ink droplets are discharged onto the region to be colored 53 from the color ink heads 202y-k and the clear ink head 208. The ink droplets are discharged from the color ink heads 202y-k to positions in the region to be colored 53 by ratios that allow desired colors to be exhibited at the positions. FIG. 4A illustrates an example of coloring pattern in a bright sky blue color. In this embodiment, the clear ink head 208 discharges the ink droplets of the clear ink so as to supplement an ink quantity per unit volume at each position in the region to be colored 53, as described earlier.

The ultraviolet curing-type inks have degrees of viscosity low enough to be dischargeable through nozzles of the inkjet heads before they start to be cured by ultraviolet light. During the main scans, therefore, ink dots formed by the ink droplets landing at target positions may continue to spread before ultraviolet irradiation starts. As such, a length of time between the arrival of ink droplets and the start of ultraviolet irradiation may be the deciding factor of the cured ink dot size (dot gain). The ink dot may decrease in height as the ink dot gain increases.

In case the ink dots after curing variously differ in height during the manufacture of a three-dimensional object using the ultraviolet curing-type inks, high precision may not be attainable in the process of shaping the object. To be more specific, in case the gains of the ink dots formed by the inkjet heads greatly differ when the ink droplets are discharged for the region to be colored 53 from the color ink heads 202y-k and the clear ink head 208 during the three-dimensional object shaping mode, it may become difficult to shape the object with high precision.

In this embodiment, however, the color ink heads 202y-k and the clear ink head 208, which are inkjet heads that discharge the ink droplets for the region to be colored 53, are collectively disposed next to one another between the UVLED1 and the UVLED2, as illustrated in FIGS. 2A and 2B. This may adequately suppress differences in time between the arrival of ink droplets and the start of ultraviolet irradiation among the ink dots formed in the region to be colored 53 during the main scans. This may adequately suppress gain differences among the ink dots formed by the inkjet heads. In this embodiment, therefore, the colored three-dimensional object may be appropriately formed with high precision.

If an unnecessarily large number of inkjet heads are interposed between the UVLED1 and the UVLED2, the UVLED1 and the UVLED2 are inevitably further spaced apart from each other. This may involve the risk of increasing differences in time between the arrival of ink droplets and the start of ultraviolet irradiation among the inkjet heads between the UVLED1 and the UVLED2 during the main scans.

In this embodiment, however, the color ink heads 202y-k and the clear ink head 208 alone, which are the inkjet heads that discharge the ink droplets for the region to be colored 53, are interposed between the UVLED1 and the UVLED2. The white ink head 206, forming material head 204, and support material head 210, which are the inkjet heads not discharging the ink droplets for the region to be colored 53, are disposed outside of the region between the UVLED1 and UVLED2.

The inkjet heads that discharge the ink droplets for the region to be colored 53 are interposed between the UVLED1 and the UVLED2, ultraviolet light sources. By arranging the inkjet heads as described above, it may be prevented that an interval between the UVLED1 and the UVLED2 already spaced apart increases more than required. This may adequately suppress gain differences of the ink dots among the inkjet heads interposed between the UVLED1 and the UVLED2. In this embodiment further providing such an aspect, the colored three-dimensional object may be appropriately formed with high precision.

In a general sense, the technical features of this embodiment may be rephrased such that the inkjet heads of the discharge unit 12 are divided into a group of coloring inkjet heads that discharge the ink droplets for the region to be colored 53 (a group of coloring heads), and a group of other inkjet heads for object shaping (a group of object-shaping heads), and the group of coloring inkjet heads includes the clear ink head 208 in addition to the color ink heads 202y-k. This structural feature may allow the colored three-dimensional object to be formed with high precision.

The discharge unit 12 may be structured otherwise with such features maintained. For example, at least one of the ultraviolet light sources 220 such as the UVLEDs may be interposed between the group of coloring heads and the group of object-shaping heads and driven in accordance with the operation mode.

In a modified example of the discharge unit 12, the inkjet heads in the group of coloring heads and the inkjet heads in the group of object-shaping heads may be displaced in the sub scanning direction. Other than the clear ink head 208 included in the group of coloring heads, the group of object-shaping heads may include a clear ink head. In the structure illustrated in FIGS. 2A and 2B, the support material head 210 is interposed between the UVLED2 and the UVLED3 to use the ultraviolet curing-type (photo-curing) support material. When support materials other than the ultraviolet curing-type support material are used, the support material head 210, instead of being interposed between the UVLED2 and the UVLED3, may be disposed at a different position.

Regardless of which one of the differently structured discharge units 12 is used, of the diameters of the ink dots formed by the inkjet heads during the three-dimensional object shaping mode, a difference between the diameters of the ink dots formed by the color ink heads 202y-k and the diameter of the ink dot formed by the clear ink head 208 may be less than a difference between the diameters of the ink dots formed by the color ink heads 202y-k and the diameter of the ink dot formed by the forming material head 204 or the like. This may more adequately suppress the gain differences of the ink dots among the inkjet heads arranged between the UVLED1 and the UVLED2.

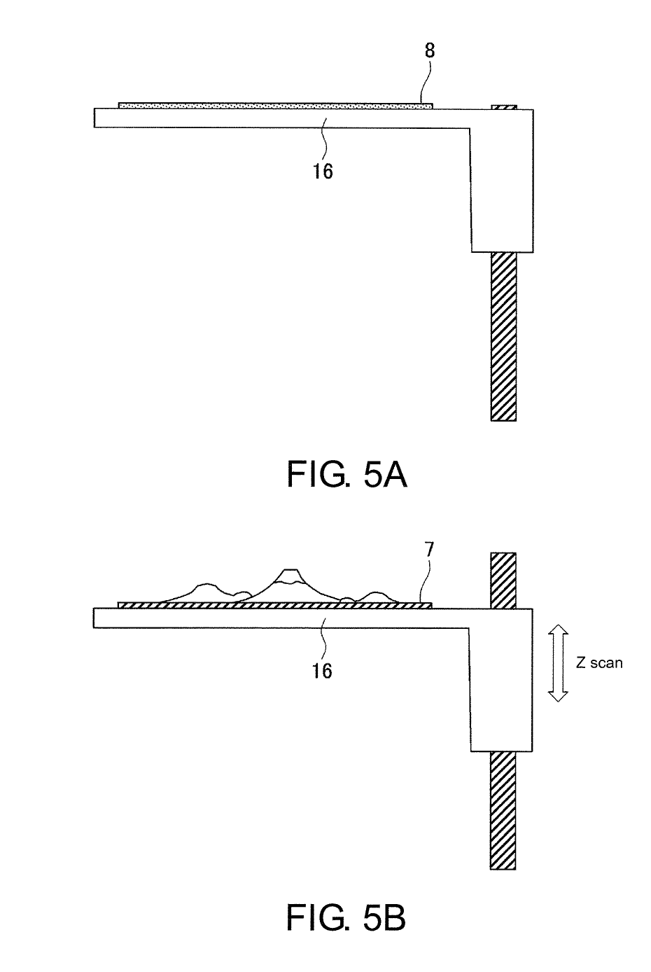

Next, operation modes other than the three-dimensional object shaping mode are described. FIGS. 5A and 5B are drawings that illustrate the operation modes other than the three-dimensional object shaping mode. As described earlier in connection with FIG. 1, the printing and object-shaping system 10 in this embodiment at least operates in the printing mode and the irregularities forming mode in addition to the three-dimensional object shaping mode. To allow the system to operate according to the different operation modes, the controller 18 in this embodiment receives an instruction to select one of the operation modes from a user through the operating unit 14. Then, the controller 18 controls the operations of the respective components in the printing and object-shaping system 10 in accordance with the operation mode selected.

FIG. 5A is a drawing that illustrates an exemplified operation during the printing mode. As described earlier, the printing mode in this embodiment is an operation mode in which a two-dimensional image is printed on a medium 8 supported on the platen 16. This operation may be the same as or similar to operations carried out by the known 2D printers. The medium 8 is a target print medium having a planar shape. Specific examples of the medium 8 may include pieces of paper, films, and plate members. The medium 8 may be a three-dimensional object or the like having irregularities formed on its surface.

In this embodiment, the printing and object-shaping system 10, during the printing mode, does not perform the Z direction scans but prints the image on the medium 8, with the platen 16 being fixed in position in the Z direction. The platen 16 is fixed to a position substantially equal in height to the discharge unit 12 to adequately reduce a distance between the discharge unit 12 and the medium 8 (discharge gap) depending on the thickness of the medium 8.

In this embodiment, the printing and object-shaping system 10 may suitably operate in the printing mode as instructed by a user, as well as in the three-dimensional object shaping mode. The printing and object-shaping system 10 may be accordingly usable in a broader range of applications.

More specifically, the medium 8 may be vacuum-suctioned and fixed to the platen 16. The medium 8 may be unwound from a roll of medium and sequentially delivered in the sub scanning direction by a roller or the like not illustrated in the drawings.

FIG. 5B is a drawing that illustrates an exemplified operation during the irregularities forming mode. As described earlier, irregularities are formed during the irregularities forming mode by a 2.5-dimensional operation defined as an operation between the two-dimensional image printing and three-dimensional object shaping operations.

More specifically, the operation during the irregularities forming mode may be an operation to form irregularities on a planar surface. By discharging the ink droplets on a planar object-shaping base 7, a three-dimensional shape with no overhang is formed on the object-shaping base 7. The object-shaping base 7 may be a target medium of the ink droplets discharged during the irregularities forming mode. A favorable example of the object-shaping base 7 may be a resin plate. During the irregularities farming mode, surface-colored irregularities may be formed on the object-shaping base 7, or uncolored irregularities may be formed on the object-shaping base 7.

The printing and object-shaping system 10 in this embodiment, during the irregularities forming mode, may form irregularities on the object-shaping base 7 without using a support material. The Z direction scans are performed as the operation advances, the platen 16 is moved in the Z direction. In this manner, the printing and object-shaping system 10 forms a three-dimensional shape with no overhang (irregularities) on the object-shaping base 7.

An example of the object-shaping base 7 may be a medium on which a two-dimensional image is partly printed. In this instance, the printing and object-shaping system 10 may operate in the printing mode illustrated in FIG. 5A before operating in the irregularities forming mode illustrated in FIG. 5B to print a two-dimensional image on a medium used as the object-shaping base 7. Examples of a product obtained by the operation during the irregularities forming mode may include a diorama or a relief. Specifically, at least a flat land and sea surface are printed in colors on the object-shaping base 7 during the printing mode, and undulations are formed to express mountains during the irregularities forming mode to obtain a 2.5D diorama illustrated in FIG. 5B. During the irregularities forming mode, the printing and object-shaping system 10 forms a three-dimensional shape with no overhang and performs color printing on the surface of the formed shape by printing.

In this embodiment, the printing and object-shaping system 10 may suitably operate in the irregularities forming mode as instructed by a user, as well as in the three-dimensional object shaping mode and the printing mode. The printing and object-shaping system 10 may be accordingly usable in even a broader range of applications.

In this embodiment, one device may carry out the operations in the three-dimensional object shaping mode, printing mode, and irregularities forming mode, providing more diverse products. The printing and object-shaping system 10 may form, on a planar image, a structure or the like associated with the image. This may enable the production of, for example, high-quality dioramas. A logo, code, and/or letters and characters such as name may be printed on a partial surface of the three-dimensional object formed during the three-dimensional object shaping mode. In this instance, the operation in the printing mode may be carried out subsequent to the operation in the three-dimensional object shaping mode. This may ensure high-precision printing for the surface of the three-dimensional object.

Using different devices separately for 3D object shaping and 2D printing may result in soaring device costs. Further, position adjustments may be necessary, possibly increasing working costs. This embodiment, on the other hand, may adequately provide a variety of products at low cost.

It may be possible to additionally print a logo, a code, and/or letters and characters such as name on a three-dimensional object by shaping the colored three-dimensional object as described with reference to FIGS. 3A, 3B, and the like. This may deteriorate an image quality as compared with an image printed on the surface of the three-dimensional object during the printing mode, and/or may require more time to shape the object. In this embodiment, on the other hand, a high-definition image presenting letters and characters may be favorably printed on the surface of the three-dimensional object. As a result, the three-dimensional object may be successfully formed with a high quality.

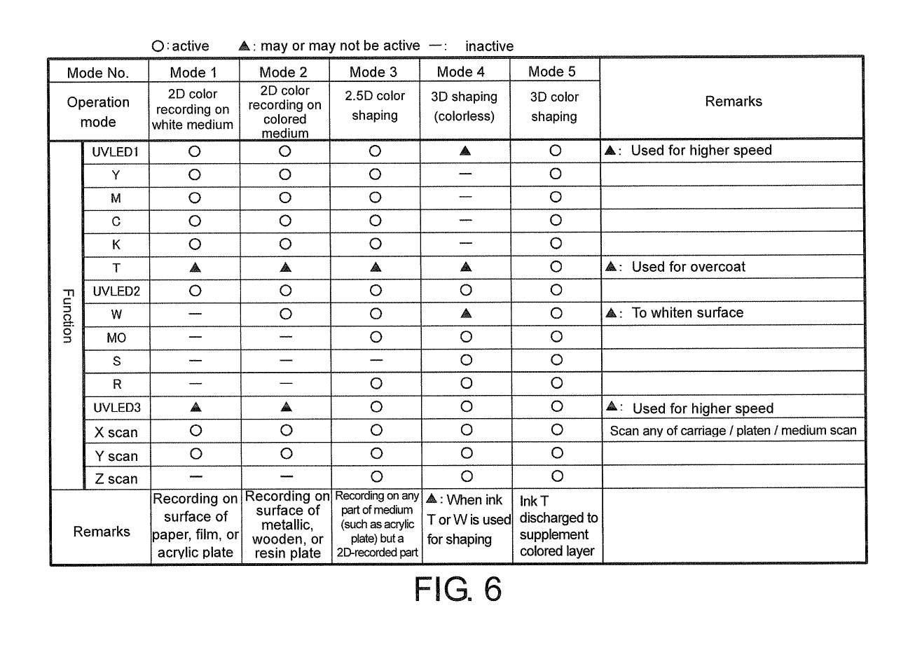

Next, the operation modes in the printing and object-shaping system 10 in this embodiment are described in further detail. FIG. 6 is a table showing exemplified operation modes of the printing and object-shaping system 10.

Specific examples of the operation modes illustrated in FIG. 6 (hereinafter, working example) include five operation modes ranging from modes 1 to 5. The modes 1 and 2 are specific examples of the printing mode. The mode 3 is a specific example of the irregularities forming mode. The modes 4 and 5 are specific examples of the three-dimensional object shaping mode. In FIG. 6, circles denote the functions of the discharge unit 12 of FIGS. 2A and 2B that are used (activated) in the respective modes. In the drawing, triangles denote the functions that may be used (activated in some cases) in accordance with operation settings, and bars denote the functions unused (inactivated) in the respective modes.

In FIG. 6, Y, M, C, K, T, W, MO, and S denote the inkjet heads that discharge the ink droplets in different colors or for different purposes. The reference sign R denotes the flattening roller unit 222. The UVLED1 to UVLED3 are the ultraviolet light sources 220.

The operations during the modes 1 to 5 in this working example are hereinafter described in further detail. The description starts with the operations during the modes 1 and 2, specific examples of the printing mode. In this working example, the modes 1 and 2 are two-dimensional printing modes. For example, the surface of a piece of plain paper, a film, or a plate member (for example, acrylic plate), which is used as a medium, is printed in colors. The printing target surface of the medium may be a planar surface, or may be a surface having fine irregularities. The medium may be a three-dimensional object.

Of the specific examples of the printing mode, the mode 1 is an operation mode for printing (recording) of a medium having a white surface. In this mode, the printing and object-shaping system 10 performs color printing by discharging the ink droplets from the color ink heads 202y-k for process colors, similarly to the conventional 2D printers used to print two-dimensional images. Among the ultraviolet light sources 220, at least one of the UVLED1 and the UVLED2 is driven to cure the inks. In case a product obtained by the printing needs, for example, glossiness or protection by a topcoat, the clear ink head 208 is used to form an overcoat layer on the product.

The UVLED1 and the UVLED2 may be both used as the ultraviolet light sources 220 in each main scan. One of the UVLED1 and the UVLED2 may be used in accordance with the moving direction of the discharge unit 12 in each main scan, in which case the ultraviolet light source 220 on the rear side in the moving direction during the main scan is driven. The UVLED3, for example, may be further driven when the curing rate is desirably increased.

Of the specific examples of the printing mode, the mode 2 is an operation mode for printing (recording) of a medium colored in any color but white. In this mode, the white ink droplets are discharged from the white ink head 206 for at least a region to be colored later by the color ink heads 202y-k to form a white ink layer, and at least one of the UVLED1 and the UVLED2 is driven to cure the white ink. This mode is similar to the mode 1 in any other aspects. Then, color printing is performed. In the mode 2 according to this working example, the white ink droplets are always the first to be discharged onto the regions to be printed, and the process color ink droplets are then discharged.

The mode 3, which is a specific example of the irregularities forming mode, is an operation mode for the operation of a 2.5D printer (2.5-dimensional printing). By forming a laminate of layers made of the forming ink (MO) discharged from the forming material head 204, three-dimensional irregularities with no overhang are formed on the object-shaping base. In this mode, at least one of the UVLED2 and the UVLED3 may be driven to cure the ink. The irregularities may be formed by discharging the white ink from the white ink head 206.

When the formed irregularities are desirably colored, the white ink droplets are discharged from the white ink head 206 onto the outer peripheral surface of the formed irregularities to form a white ink layer. The white ink layer is necessary for color representations by the subtractive color mixture in the process color ink layers formed later.

Afterwards, the process color ink droplets are discharged from the color ink heads 202y-k onto the white ink layer to color the irregularities. In this mode, at least one of the UVLED1 and the UVLED2 is driven to cure the inks. The UVLED3 may be further driven when the curing rate is desirably increased.

The modes 4 and 5, which are specific examples of the three-dimensional object shaping mode, are operation modes for shaping an optional three-dimensional object with an overhanging portion. The mode 4 is an operation mode solely for object shaping. The mode 5 is an operation mode that involves coloring and object shaping.

In the mode 4, layers made of the forming ink (MO) are stacked on one another by using the forming material head 204, UVLED2, and UVLED3 to shape a three-dimensional object. If necessary, the support material for shaping the overhanging portion may be discharged from the support material head 210 at the same time as the formation of the layers made of the forming ink (MO). Further, a white ink layer is formed on the surface of the three-dimensional object by using the white ink head 206, if necessary. The white ink layer is necessary for color representations by the subtractive color mixture in case the surface of the three-dimensional object is colored later.

In the mode 5, a three-dimensional object is shaped and colored at the same time by using all of the inkjet heads of the discharge unit 12 and the three ultraviolet light sources 220 (UVLED1 to UVLED3). The operation in this mode was described earlier with reference to, for example, FIGS. 3A, 3B, 4A, and 4B.

The operation modes of the printing and object-shaping system 10 may not necessarily be limited to the modes 1 to 5 and may further include other operation modes. Examples of the additional operation modes may include an operation mode for shaping a white three-dimensional object by using the white ink head 206, UVLED2, and UVLED3, an operation mode for shaping a three-dimensional object made of the clear ink by using the clear ink head 208, UVLED1, and UVLED2, and an operation mode for shaping a three-dimensional object having an optional color(s) by combining the clear ink head 208, color ink heads 202y-k, UVLED1, and UVLED2.

In the embodiment described thus far, the inkjet heads for process color printing, and the inkjet heads for object shaping are mounted together in the carriage, and the operation modes are changed by the controller 18 as instructed by a user to allow one device to appropriately carry out the two-dimensional color printing (2D printing), 2.5-dimensional shaping (2.5D printing), and three-dimensional object shaping (3D printing) operations. By using the ultraviolet curing-type inks as the coloring and forming inks, the same post-processes may be employed subsequent to the ink droplets discharge, and the ultraviolet light sources may be appropriately and commonly used throughout the 2D printing, 2.5D printing, and 3D printing operations. In the printing and object-shaping system 10 using the platen 16 movable upward and downward, discharge gap adjustments in 2D printing, and scans in the thickness direction (vertical direction) for lamination in 2.5D and 3D printing may be configured likewise. According to this working example, one three-dimensional object shaping device may be usefully applicable to a broader range of applications.

In this working example, 2D printing, 2.5D printing, and 3D printing operations may be timely switched to one another. The operations in different operation modes, therefore, may be successively carried out. For example, a three-dimensional object may be successively shaped on a two-dimensional image. A two-dimensional image, such as a logo, may be printed in a subsequent step on a particular part of a three-dimensional object shaped by the 3D printing operation. Accordingly, the printing and object-shaping system 10 may be operable to manufacture a variety of products.

This invention was thus far described in connection with the embodiment.

However, the technical scope of this invention is not limited to the technical aspects described in the embodiment. It is obvious to those skilled in the art that the embodiment may be variously modified and/or improved. The technical scope of this invention encompasses any of such modifications and/or improvements as is clearly known from the appended claims.

### INDUSTRIAL APPLICABILITY

This invention is suitably applicable to printing and object-shaping systems.

1. A liquid drop discharge device configured to discharge ink droplets by inkjet printing, the liquid drop discharge device comprising:
an inkjet head that discharges ink droplets of an ink including a curable resin that is curable under predetermined conditions;
a curing unit that cures the curable resin;
a table-shaped member disposed at a position so as to face the inkjet head; and
a controller configured to control operations of at least the inkjet head and the curing unit,
wherein
the liquid drop discharge device is operable to carry out operations in a printing mode and a three-dimensional object shaping mode, the printing mode being a mode for performing printing on a medium supported on the table-shaped member and the three-dimensional object shaping mode being a mode for depositing the ink in layers on the table-shaped member to form a three-dimensional object, and
the controller is further configured to receive an instruction to select one of the printing mode and the three-dimensional object shaping mode and to control operations of at least the inkjet head and the curing unit in accordance with the mode selected.

2. The liquid drop discharge device as set forth in claim 1, further comprising:
a mode changing unit that switches between the printing mode and the three-dimensional object shaping mode, wherein
the controller receives an instruction from a user to select one of the printing mode and the three-dimensional object shaping mode through the mode changing unit.

3. The liquid drop discharge device as set forth in claim 1, wherein
the liquid drop discharge device is further operable to carry out an operation in an irregularities forming mode to form irregularities on a planar surface; and
the controller receives an instruction to select any one of the printing mode, the three-dimensional object shaping mode, and the irregularities forming mode, and controls operations of at least the inkjet head and the curing unit in accordance with the mode selected.

4. The liquid drop discharge device as set forth in claim 1, wherein
the curable resin is an ultraviolet curing-type resin curable by being irradiated with ultraviolet light; and
the curing unit is an ultraviolet light source that emits ultraviolet light to cure the ultraviolet curing-type resin.

5. The liquid drop discharge device as set forth in claim 1, wherein
the curable resin is an ultraviolet curing-type resin curable by being irradiated with ultraviolet light, and
the controller prompts the inkjet head to perform main scans in which the inkjet head discharges the ink droplets while moving in a main scanning direction which is predetermined,
wherein
the liquid drop discharge device comprises:
a plurality of color ink heads as the inkjet head, the plurality of color ink heads discharging ink droplets of color inks having different colors;
a clear ink head that discharges ink droplets of a clear ink that is a transparent ink; and
a forming material head that discharges ink droplets of a forming ink used to shape the three-dimensional object at least when the three-dimensional object shaping mode is selected,
wherein
at least when the three-dimensional object that is colored is formed during the three-dimensional object shaping mode selected, the controller prompts the plurality of color ink heads and the clear ink head to discharge the ink droplets onto a region to be colored of the three-dimensional object where coloration is visually recognizable from outside of the three-dimensional object, and
the plurality of color ink heads and the clear ink head are arranged in the main scanning direction in positional alignment with one another in a direction orthogonal to the main scanning direction,
wherein
the liquid drop discharge device comprises first and second light sources as the curing unit, the first and second light sources being ultraviolet light sources that emit ultraviolet light to cure the ultraviolet curing-type resin,
the first light source is disposed on one side in the main scanning direction of arrangement of the plurality of color ink heads and the clear ink head,
the second light source is disposed on another side in the main scanning direction of arrangement of the plurality of color ink heads and the clear ink head, and
the forming material head is disposed outside of a region between the first and second light sources.

6. The liquid drop discharge device as set forth in claim 5, wherein the forming material head is positioned across the second light source from arrangement of the color ink heads and the clear ink head.

7. The liquid drop discharge device as set forth in claim 6, further comprising:
a third light source as the curing unit, the third light source being an ultraviolet light source that emits ultraviolet light for curing the ultraviolet curing-type resin, wherein
the third light source is positioned opposite to the second light source across the forming material head in the main scanning direction.

8. A liquid drop discharge method of discharging ink droplets by inkjet printing, the liquid drop discharge method comprising receiving an instruction to select one of a printing mode and a three-dimensional object shaping mode,
the printing mode being a mode for performing printing on a medium supported on a table-shaped member facing an inkjet head, the printing mode including use of:
the inkjet head that discharges ink droplets of an ink containing a curable resin that is curable under predetermined conditions;
a curing unit that cures the curable resin; and
the table-shaped member,
the three-dimensional object shaping mode being a mode for depositing the ink in layers on the table-shaped member to form a three-dimensional object, and
the liquid drop discharge method further comprising controlling operations of at least the inkjet head and the curing unit in accordance with the mode selected.

9. The liquid drop discharge device as set forth in claim 2, wherein the curable resin is an ultraviolet curing-type resin curable by being irradiated with ultraviolet light, and
the controller prompts the inkjet head to perform main scans in which the inkjet head discharges the ink droplets while moving in a main scanning direction which is predetermined,
wherein
the liquid drop discharge device comprises:
a plurality of color ink heads as the inkjet head, the plurality of color ink heads discharging ink droplets of color inks having different colors;
a clear ink head that discharges ink droplets of a clear ink that is a transparent ink; and
a forming material head that discharges ink droplets of a forming ink used to shape the three-dimensional object at least when the three-dimensional object shaping mode is selected,
wherein
at least when the three-dimensional object that is colored is formed during the three-dimensional object shaping mode selected, the controller prompts the plurality of color ink heads and the clear ink head to discharge the ink droplets onto a region to be colored of the three-dimensional object where coloration is visually recognizable from outside of the three-dimensional object, and
the plurality of color ink heads and the clear ink head are arranged in the main scanning direction in positional alignment with one another in a direction orthogonal to the main scanning direction,
wherein
the liquid drop discharge device comprises first and second light sources as the curing unit, the first and second light sources being ultraviolet light sources that emit ultraviolet light to cure the ultraviolet curing-type resin,
the first light source is disposed on one side in the main scanning direction of arrangement of the plurality of color ink heads and the clear ink head,
the second light source is disposed on another side in the main scanning direction of arrangement of the plurality of color ink heads and the clear ink head, and
the forming material head is disposed outside of a region between the first and second light sources.

10. The liquid drop discharge device as set forth in claim 3, wherein the curable resin is an ultraviolet curing-type resin curable by being irradiated with ultraviolet light, and
the controller prompts the inkjet head to perform main scans in which the inkjet head discharges the ink droplets while moving in a main scanning direction which is predetermined,
wherein
the liquid drop discharge device comprises:
a plurality of color ink heads as the inkjet head, the plurality of color ink heads discharging ink droplets of color inks having different colors;
a clear ink head that discharges ink droplets of a clear ink that is a transparent ink; and
a forming material head that discharges ink droplets of a forming ink used to shape the three-dimensional object at least when the three-dimensional object shaping mode is selected,
wherein
at least when the three-dimensional object that is colored is formed during the three-dimensional object shaping mode selected, the controller prompts the plurality of color ink heads and the clear ink head to discharge the ink droplets onto a region to be colored of the three-dimensional object where coloration is visually recognizable from outside of the three-dimensional object, and
the plurality of color ink heads and the clear ink head are arranged in the main scanning direction in positional alignment with one another in a direction orthogonal to the main scanning direction,
wherein
the liquid drop discharge device comprises first and second light sources as the curing unit, the first and second light sources being ultraviolet light sources that emit ultraviolet light to cure the ultraviolet curing-type resin,
the first light source is disposed on one side in the main scanning direction of arrangement of the plurality of color ink heads and the clear ink head,
the second light source is disposed on another side in the main scanning direction of arrangement of the plurality of color ink heads and the clear ink head, and
the forming material head is disposed outside of a region between the first and second light sources.

11. The liquid drop discharge device as set forth in claim 4, wherein the curable resin is an ultraviolet curing-type resin curable by being irradiated with ultraviolet light, and
the controller prompts the inkjet head to perform main scans in which the inkjet head discharges the ink droplets while moving in a main scanning direction which is predetermined,
wherein
the liquid drop discharge device comprises:
a plurality of color ink heads as the inkjet head, the plurality of color ink heads discharging ink droplets of color inks having different colors;
a clear ink head that discharges ink droplets of a clear ink that is a transparent ink; and
a forming material head that discharges ink droplets of a forming ink used to shape the three-dimensional object at least when the three-dimensional object shaping mode is selected,
wherein
at least when the three-dimensional object that is colored is formed during the three-dimensional object shaping mode selected, the controller prompts the plurality of color ink heads and the clear ink head to discharge the ink droplets onto a region to be colored of the three-dimensional object where coloration is visually recognizable from outside of the three-dimensional object, and
the plurality of color ink heads and the clear ink head are arranged in the main scanning direction in positional alignment with one another in a direction orthogonal to the main scanning direction,
wherein
the liquid drop discharge device comprises first and second light sources as the curing unit, the first and second light sources being ultraviolet light sources that emit ultraviolet light to cure the ultraviolet curing-type resin,
the first light source is disposed on one side in the main scanning direction of arrangement of the plurality of color ink heads and the clear ink head,
the second light source is disposed on another side in the main scanning direction of arrangement of the plurality of color ink heads and the clear ink head, and
the forming material head is disposed outside of a region between the first and second light sources.
